(19) United States
(12) Patent Application Publication
(10) Pub. No.: US 2017/0117650 A1
(43) Pub. Date: Apr. 27, 2017

(54) Surface Protective Agent Composition, Electric Connection Structure Using Same, and Method for Manufacturing Electric Connection Structure

(71) Applicants: JX Nippon Oil & Energy Corporation, Tokyo (JP); Sumitomo Electric Industries, Ltd., Osaka (JP); Sumitomo Wiring Systems, Ltd., Mie (JP); Autonetworks Technologies, Ltd., Mie (JP); Kyushu University, National University Corporation, Fukuoka (JP)

(72) Inventors: Koichi Yoshida, Tokyo (JP); Takashi Arai, Tokyo (JP); Yuji Shitara, Tokyo (JP); Kenichi Komiya, Tokyo (JP); Makoto Mizoguchi, Fukuoka (JP); Hideki Nomura, Mie (JP); Takuji Otsuka, Mie (JP); Junichi Ono, Mie (JP); Hiroki Hirai, Mie (JP); Kazuo Nakashima, Mie (JP); Tatsuya Hase, Mie (JP); Takehiro Hosokawa, Mie (JP); Kazuhiro Goto, Osaka (JP)

(73) Assignees: JX Nippon Oil & Energy Corporation, Tokyo (JP); Sumitomo Electric Industries, Ltd., Osaka (JP); Sumitomo Wiring Systems, Ltd., Mie (JP); Autonetworks Technologies, Ltd., Mie (JP); Kyushu University, National University Corporation, Fukuoka (JP)

(21) Appl. No.: 15/127,998

(22) PCT Filed: Mar. 24, 2015
(86) PCT No.: PCT/JP2015/058931

§ 371 Date: Sep. 21, 2016

(30) Foreign Application Priority Data
Mar. 24, 2014 (JP) 2014-059701
Feb. 6, 2015 (JP) 2015-021759

(51) Int. Cl. H01R 13/03; C10M 169/04; H01R 4/62; H01R 43/00; H01R 4/18; H01R 4/20

(52) U.S. Cl. CPC H01R 13/03; H01R 4/185; H01R 4/20; H01R 4/62; H01R 43/00; C10M 169/044; C10M 2203/1006; C10M 2223/042; C10M 2215/08; C10M 2215/223; C10M 2219/00; C10M 2207/023; C10M 2205/02; C10M 2207/144; C10N 2240/202; C10N 2230/10; C10N 2230/12; C10N 2250/10

(57) ABSTRACT

To provide a surface protective agent composition that suppresses corrosion of members of different kinds of metals close to each other due to corrosion current between the metals of the members, and to provide an electric connection structure and a method for producing an electric connection structure using the same. The surface protective agent composition contains (a) a lubricant base oil; (b) a prescribed amount of at least one compound selected from the group consisting of particular phosphorus compounds and a metal salt or an amine salt thereof; and (c) a prescribed amount of an amide compound, and in the case where the component (b) does not contain the metal salt of the phosphorus compound, the surface protective agent composition further contains (d) a prescribed amount of a salicylate of a particular metal and/or a basic (or perbasic) salt thereof, and the electric connection structure containing a surface protective layer consisting of the surface protective agent composition.

### TECHNICAL FIELD

The present invention relates to a surface protective agent composition, and an electric connection structure and a method for producing electric connection structure using the same, and more specifically relates to a surface protective agent composition excellent in corrosion suppression capability to a metal member, and an electric connection structure and a method for producing electric connection structure using the same.

### BACKGROUND ART

In a portion where two metal members are electrically connected, such as an engagement portion of a terminal and a wire or terminals, there are some cases where the materials constituting the terminal and the wire, the materials constituting one of the terminals and the counter terminal, or the materials of a metal plate constituting the terminal and a plated layer formed on the metal plate are constituted by different kinds of metals.

In these cases where members constituted by different kinds of metals are disposed at positions close to each other, there may be a possibility that corrosion current flows between the different kinds of metals due to water (particularly an aqueous solution containing an ion, such as chloride) attached between them. For preventing the problem, such a practice has been performed that grease or the like is applied to the connecting part between the terminals, or the like (see, for example, PTL 1).

There has been a proposal of a surface treating agent containing from 30 to 95% by mass of a volatile liquid having a boiling point of 300° C. or less, from 1 to 50% by mass of a lubricant oil and/or a rust preventing agent, and from 0.1 to 50% by mass of a compound having an amide group, capable of forming a thin film excellent in rust preventing capability on a surface of a material to be processed or a machine component by dipping the material or the component in the surface treating agent or by coating the surface treating agent thereon and then drying (see, for example, PTL5 2 and 3). However, it is difficult to prevent the corrosion current between different kinds of metals by the surface treating agent.

In the case where an oily component, such as grease, is applied as described in PTL 1, the oily component may impair the workability due to the stickiness or dripping thereof, and furthermore may contaminate the surrounding base material. Accordingly, the oily component is necessarily applied as thinly as possible. However, if the oily component is applied too thinly, it may be difficult to retain a stable oil film on the metal surface for a prolonged period of time. Under a high temperature condition, in particular, reduction in molecular weight due to oxidation of the oily component or vaporization thereof may occur, and it is more difficult to retain a stable oil film on the metal surface. This is because the oily component is not chemically bonded to the metal surface but is adhered to the metal surface through the van der Waals force, which has a small attracting force.

### CITATION LIST

### Patent Literatures

PTL 1: JP-A-5-159846

PTL 2: WO 2009/022629

PTL 3: JP-A-2013-253166

### SUMMARY OF INVENTION

### Technical Problem

The invention has been made in view of the circumstances, and a problem to be solved by the invention is to provide a surface protective agent composition that suppresses corrosion of members of different kinds of metals close to each other due to corrosion current between the metals of the members, and to provide an electric connection structure and a method for producing an electric connection structure using the same.

### Solution to Problem

As a result of earnest investigations made by the present inventors for solving the problem, it has been found that it is effective that a first metal member containing copper or copper alloy (which may have a tin plated layer on a part or the whole thereof), a second metal member electrically connected to the first metal member, and a surface protective layer formed on a surface of the first metal member are provided, and the surface protective layer is formed by applying a surface protective agent composition having a particular structure, and thus the invention has been completed.

The invention is as follows.

[1] A surface protective agent composition comprising:

(a) a lubricant base oil;

(b) at least one compound selected from the group consisting of a phosphorus compound represented by the following general formula (1), a phosphorus compound represented by the following general formula (2), and a metal salt or an amine salt thereof, in an amount of from 0.005 to 4% by mass in terms of phosphorus element based on the total amount of the composition:

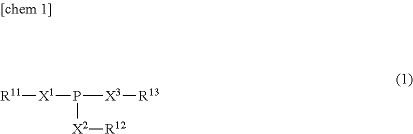

wherein in the general formula (1), X¹, X², and X³ each independently represent an oxygen atom or a sulfur atom, provided that at least one thereof represents an oxygen atom; and R¹¹, R¹², and R¹³ each independently represent a hydrogen atom or a hydrocarbon group having from 1 to 30 carbon atoms;

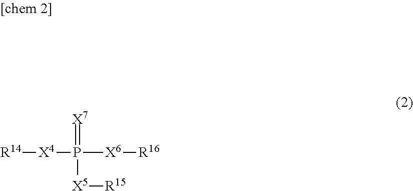

wherein in the general formula (2), X⁴, X⁵, X⁶, and X⁷ each independently represent an oxygen atom or a sulfur atom, provided that at least three thereof represent oxygen atoms; and R¹⁴, R¹⁵, and R¹⁶ each independently represent a hydrogen atom or a hydrocarbon group having from 1 to 30 carbon atoms; and

(c) an amide compound, in an amount of from 0.1 to 40% by mass based on the total amount of the composition, and

in the case where the component (b) neither contains the metal salt of the phosphorus compound represented by the general formula (1) nor the metal salt of the phosphorus compound represented by the general formula (2), the surface protective agent composition further comprising:

(d) a salicylate of an alkali metal or an alkaline earth metal having an alkyl group or an alkenyl group having from 10 to 40 carbon atoms, and/or a basic (or perbasic) salt thereof, in an amount of from 0.005 to 3.0% by mass in terms of metal element based on the total amount of the composition.

The surface protective agent composition according to the item [1], wherein the surface protective agent composition comprises (d) a salicylate of an alkali metal or an alkaline earth metal having an alkyl group or an alkenyl group having from 10 to 40 carbon atoms, and/or a basic (or perbasic) salt thereof, in an amount of from 0.005 to 3.0% by mass in terms of metal element based on the total amount of the composition.

[3] The surface protective agent composition according to the item [1] or [2], wherein the surface protective agent composition further comprises (e) at least one metal deactivator having a nitrogen-containing heterocyclic ring in the molecule thereof, in an amount of from 0.01 to 30% by mass based on the total amount of the composition.

[4] The surface protective agent composition according to any one of the items [1] to [3], wherein the lubricant base oil (a) has a kinematic viscosity at 100° C. of from 2 to 50 mm²/s.

[5] The surface protective agent composition according to any one of the items [1] to [4], wherein the lubricant base oil (a) has % C_{P} obtained by a method determined in ASTM D3238 of less than 90%.

The surface protective agent composition according to any one of the items [1] to [5], wherein the phosphorus compound represented by the general formula (1) and the phosphorus compound represented by the general formula (2) (b) each are at least one compound selected from the group consisting of metal salts thereof, and the metal is selected from the group consisting of an alkali metal, an alkaline earth metal, aluminum, titanium, and zinc.

[7] The surface protective agent composition according to any one of the items [1] to [6], wherein the phosphorus compound represented by the general formula (1) and the phosphorus compound represented by the general formula (2) (b) each are at least one compound selected from the group consisting of metal salts thereof, and the metal is any one of calcium, magnesium, and zinc.

[8] The surface protective agent composition according to any one of the items [1] to [7], wherein in the general formula (2) of at least one compound selected from the group consisting of the phosphorus compound represented by the general formula (2) and a metal salt or an amine salt thereof (b), all X⁴, X⁵, X⁶, and X⁷ are oxygen atoms, and at least one of R¹⁴, R¹⁵, and R¹⁶ is a hydrocarbon group having from 1 to 30 carbon atoms.

[9] The surface protective agent composition according to any one of the items [1] to [7], wherein in the general formula (2) of at least one compound selected from the group consisting of the phosphorus compound represented by the general formula (2) and a metal salt or an amine salt thereof (b), all X⁴, X⁵, X⁶, and X⁷ are oxygen atoms, and at least one of R¹⁴, R¹⁵, and R¹⁶ is a branched hydrocarbon group having from 8 to 30 carbon atoms.

[10] The surface protective agent composition according to any one of the items [1] to [9], wherein the amide compound (c) is at least one represented by the following general formulae (3) to (5):

R²¹—CO—NH—R²² (3)

R²³—CO—NH—Y³¹—NH—CO—R²⁴ (4)

R²⁵—NH—CO—Y³²—CO—NH—R²⁶ (5)

wherein in the general formulae (3) to (5), R²¹, R²², R²³, R²⁴, R²⁵, and R²⁶ each independently represent a saturated or unsaturated chain hydrocarbon group having from 5 to 25 carbon atoms, provided that R²² may be a hydrogen atom; and Y³¹ and Y³² each represent a divalent hydrocarbon group having from 1 to 10 carbon atoms selected from the group consisting of an alkylene group having from 1 to 10 carbon atoms, a phenylene group, and an alkylphenylene group having from 7 to 10 carbon atoms.

[11] The surface protective agent composition according to the item [10], wherein the amide compound (c) is at least one represented by the general formulae (3) to (5), and is an amide compound, in which R²¹, R²², R²³, R²⁴, R²⁵, and R²⁶ each independently represent a saturated chain hydrocarbon group having from 12 to 20 carbon atoms, or R²² is a hydrogen atom, and/or an amide compound, in which at least one of R²¹ and R²², R²³ and R²⁴, and R²⁵ and R²⁶ each are an unsaturated chain hydrocarbon group having from 12 to 20 carbon atoms.

[12] The surface protective agent composition according to any one of the items [1] to [11], wherein the amide compound (c) is a fatty acid amide having a melting point of from 20 to 200° C.

[13] The surface protective agent composition according to any one of the items [1] to [12], wherein the salicylate of an alkali metal or an alkaline earth metal having an alkyl group or an alkenyl group having from 10 to 40 carbon atoms, and/or a basic (or perbasic) salt thereof (d) is calcium salicylate having an alkyl group or an alkenyl group having from 10 to 40 carbon atoms, and/or a basic (or perbasic) salt thereof.

[14] The surface protective agent composition according to any one of the items [1] to [13], wherein the salicylate of an alkali metal or an alkaline earth metal having an alkyl group or an alkenyl group having from 10 to 40 carbon atoms, and/or a basic (or perbasic) salt thereof (d) is a salicylate of an alkali metal or an alkaline earth metal having an alkyl group or an alkenyl group having from 10 to 40 carbon atoms, and/or a basic (or perbasic) salt thereof that has a metal ratio of from 1 to 7.5.

[15] The surface protective agent composition according to any one of the items [3] to [14], wherein the metal deactivator having a nitrogen-containing heterocyclic ring in the molecule thereof (e) is at least one selected from the group consisting of a benzotriazole-based compound, a tolyltriazole-based compound, a benzothiazole-based compound, a thiadiazole-based compound, and an imidazole-based compound.

[16] The surface protective agent composition according to any one of the items [3] to [15], wherein the metal deactivator having a nitrogen-containing heterocyclic ring in the molecule thereof (e) is at least one compound having a hydrocarbon group having 4 or more carbon atoms.

[17] The surface protective agent composition according to any one of the items [3] to [16], wherein the metal deactivator having a nitrogen-containing heterocyclic ring in the molecule thereof (e) is at least one compound having a linear or branched hydrocarbon group having 8 or more carbon atoms.

[18] The surface protective agent composition according to any one of the items [1] to [17], wherein the surface protective agent composition further comprises (f) an antioxidant, in an amount of from 0.01 to 5% by mass based on the total amount of the composition.

[19] The surface protective agent composition according to the item [18], wherein the antioxidant (f) is at least one selected from the group consisting of a phenol-based antioxidant and an amine-based antioxidant. [20] The surface protective agent composition according to the item [18], wherein the antioxidant (f) is at least one selected from the group consisting of alkylphenol compounds and bisphenol compounds.

[21] The surface protective agent composition according to any one of the items [1] to [20], wherein the surface protective agent composition further comprises (g) a thickener, in an amount of from 0.1 to 20% by mass based on the total amount of the composition.

[22] The surface protective agent composition according to the item [21], wherein the thickener (g) is at least one selected from the group consisting of a polyalkyl methacrylate, an ethylene-α-olefin copolymer and a hydrogenated product thereof, and polyisobutylene and a hydrogenated product thereof.

[23] The surface protective agent composition according to any one of the items [1] to [22], wherein the surface protective agent composition further comprises (h) grease, in an amount of from 0.1 to 10% based on the total amount of the composition.

[24] The surface protective agent composition according to the item [23], wherein the grease (h) is lithium-based grease.

[25] The surface protective agent composition according to any one of the items [1] to [24], wherein the surface protective agent composition further contains (i) a dye.

[26] The surface protective agent composition according to any one of the items [1] to [25], wherein the surface protective agent composition has a melting point of from 120 to 150° C.

[27] An electric connection structure comprising a first metal member containing copper or copper alloy, and a second metal member electrically connected to the first metal member, and further comprising a surface protective layer consisting of the surface protective agent composition according to any one of the items [1] to [26] on at least a surface of the first metal member.

[28] The electric connection structure according to the item [27], wherein the first metal member containing copper or copper alloy has a tin plated layer on at least a part thereof.

[29] The electric connection structure according to the item [27] or [28], wherein the second metal member is aluminum or aluminum alloy.

[30] The electric connection structure according to the item [27] or [28], wherein the second metal member is an aluminum wire or an aluminum alloy wire.

[31] The electric connection structure according to the item [27] or [28], wherein the second metal member is copper or copper alloy.

[32] The electric connection structure according to the item [27] or [28], wherein the second metal member is a copper wire or a copper alloy wire.

[33] A method for suppressing corrosion of an electric connection structure, wherein the electric connection structure containing a first metal member containing copper or copper alloy, and a second metal member electrically connected to the first metal member, and wherein the method comprising providing a surface protective layer consisting of the surface protective agent composition according to any one of the items [1] to [26] on at least a surface of the first metal member.

[34] The electric connection structure according to any one of the items [27] to [32], wherein the surface protective layer is formed by dip-coating the surface protective agent composition according to anyone of the items [1] to [26] heated to a melting point thereof or more.

[35] A method for producing an electric connection structure according to any one of the items [27] to [32], comprising forming the surface protective layer by dip-coating the surface protective agent composition according to any one of the items [1] to [26] heated to a melting point thereof or more.

[36] A wire harness for an automobile, comprising the electric connection structure according to anyone of the items [27] to [32] and [34].

[37] A method for reducing a weight of an automobile, using the wire harness for an automobile according to the item [36].

### Advantageous Effects of Invention

The surface protective agent composition of the invention can suppress corrosion of a metal member in an electric connection structure of the metal member.

The surface protective agent composition of the invention also can enhance the corrosion resistance of the metal member under a severe corrosive environment, and thus can enhance the resistance of wiring of a transport equipment, such as a wire harness for an automobile.

Furthermore, the electric connection structure having the surface protective agent composition of the invention coated thereon can suppress the corrosion resistance of aluminum (or alloy thereof), the corrosion suppression for which has been difficult under a corrosive environment.

Moreover, the electric connection structure having the surface protective agent composition of the invention coated thereon can enable the use of aluminum (or alloy thereof), which is effective for weight reduction of an vehicle, as a material of a core wire of a wire harness, and therefore the electric connection structure can contribute to weight reduction of an automobile, and can contribute to reduction of the fuel consumption and reduction of the carbon dioxide emission amount of an automobile.

### BRIEF DESCRIPTION OF DRAWINGS

FIG. 1 is a schematic diagram for describing an electric connection structure of the embodiment 1 of the invention.

FIG. 2 is a schematic diagram for describing an electric connection structure of the embodiment 1 of the invention.

FIG. 3 is a schematic diagram for describing an electric connection structure of the embodiment 1 of the invention.

FIG. 4 is a schematic diagram for describing an electric connection structure of the embodiment 2 of the invention.

### DESCRIPTION OF EMBODIMENTS

The contents of the invention will be described in more detail below.

The surface protective agent composition of the invention contains (a) a lubricant base oil (which may hereinafter referred to as a component (a)).

The component (a) used may be an arbitrary mineral oil, an arbitrary wax isomerized oil, and an arbitrary synthetic oil, or a mixture of two or more kinds thereof.

Specific examples of the mineral oil used include a paraffin oil, a naphthene oil, and a n-paraffin, which may be obtained in such a manner that a crude oil is distilled under ordinary pressure or distilled under reduced pressure to provide a lubricant oil fraction, which is then purified by appropriately combining purification treatments, such as solvent deasphaltation, solvent extraction, hydrocracking, solvent dewaxing, catalytic dewaxing, hydrorefining, sulfuric acid treatment, and white clay treatment.

Examples of the wax isomerized oil used include one prepared through a hydrogen isomerization treatment of a wax raw material, such as natural wax, e.g., petroleum slack wax obtained through solvent dewaxing of a hydrocarbon oil, and such as synthetic wax formed by the so-called Fischer Tropsch synthetic process, in which a mixture of carbon monoxide and hydrogen is made in contact with a suitable synthetic catalyst at a high temperature and a high pressure. In the case where slack wax is used as the wax raw material, the slack wax contains large amounts sulfur and nitrogen, which are unnecessary in the lubricant base oil, and therefore it is desirable that the slack wax is hydrogenated depending on necessity to prepare wax having been reduced in the sulfur content and the nitrogen content, which is thus used as a raw material.

The synthetic oil is not particularly limited, and examples thereof used include a poly-α-olefin (such as a 1-octene oligomer, a 1-decene oligomer, and an ethylene-propylene oligomer) and a hydrogenated product thereof, an isobutene oligomer and a hydrogenated product thereof, an isoparaffin, an alkylbenzene, an alkylnaphthalene, a diester (such as ditridecyl glutarate, di-2-ethylhexyl adipate, diisodecyl adipate, ditridecyl adipate, and di-2-ethylhexyl sebacate), a polyol ester (such as trimethylolpropane caprylate, trimethylolpropane pelargonate, pentaerythritol 2-ethylhexanoate, and pentaerythritol pelargonate), a polyoxyalkylene glycol, a dialkyl diphenyl ether, and a polyphenyl ether.

The kinematic viscosity of the lubricant base oil is not particularly limited and may be arbitrarily determined, and generally the kinematic viscosity at 100° C. is preferably from 1 to 70 mm²/s. The kinematic viscosity at 100° C. is more preferably from 2 to 50 mm²/s since the lubricant base oil may be excellent in the volatility and the handleability in production.

The paraffin component content of the lubricant base oil is preferably less than 90% since the surface protective agent composition may be excellent in the dissolution stability. The paraffin component content herein means % C_{P} obtained by a method determined in ASTM D3238.

The amount of the lubricant base oil mixed is the rest of the composition of the invention, and is preferably at least 15% by mass or more.

The surface protective agent composition of the invention contains (b) at least one compound selected from the group consisting of a phosphorus compound represented by the following general formula (1), a phosphorus compound represented by the following general formula (2), and a metal salt or an amine salt thereof (which may hereinafter referred to as a component (b)).

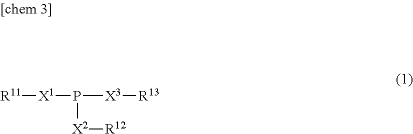

In the general formula (1), X¹, X², X³ each independently represent an oxygen atom or a sulfur atom, provided that at least one thereof represents an oxygen atom; and R¹¹, R¹², and R¹³ each independently represent a hydrogen atom or a hydrocarbon group having from 1 to 30 carbon atoms.

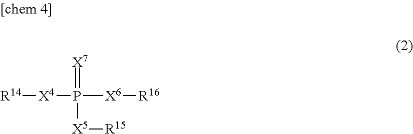

In the general formula (2), X⁴, X⁵, X⁶, and X⁷ each independently represent an oxygen atom or a sulfur atom, provided that at least three thereof represent oxygen atoms; and R¹⁴, R¹⁵, and R¹⁶ each independently represent a hydrogen atom or a hydrocarbon group having from 1 to 30 carbon atoms.

Examples of the hydrocarbon group having from 1 to 30 carbon atoms represented by R¹¹ to R¹⁶ include an alkyl group, a cycloalkyl group, an alkenyl group, an alkyl-substituted cycloalkyl group, an aryl group, an alkyl-substituted aryl group, and an arylalkyl group.

Examples of the alkyl group include such an alkyl group (which may be linear or branched) as a methyl group, an ethyl group, a propyl group, a butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, and an octadecyl group.

Examples of the cycloalkyl group include a cycloalkyl group having from 5 to 7 carbon atoms, such as a cyclopentyl group, a cyclohexyl group, and a cycloheptyl group. Examples of alkylcycloalkyl group include an alkylcycloalkyl group having from 6 to 11 carbon atoms (in which the alkyl group may be substituted on the cycloalkyl group at an arbitrary position), such as a methylcyclopentyl group, a dimethylcyclopentyl group, a methylethylcyclopentyl group, a diethylcyclopentyl group, methylcyclohexyl group, a dimethylcyclohexyl group, a methylethylcyclohexyl group, a diethylcyclohexyl group, a methylcycloheptyl group, a dimethylcycloheptyl group, a methylethylcycloheptyl group, and diethylcycloheptyl group.

Examples of the alkenyl group include such an alkenyl group (which may be linear or branched and may have the double bond at an arbitrary position) as a butenyl group, a pentenyl group, a hexenyl group, a heptenyl group, an octenyl group, a nonenyl group, a decenyl group, an undecenyl group, a dodecenyl group, a tridecenyl group, a tetradecenyl group, a pentadecenyl group, a hexadecenyl group, a heptadecenyl group, and an octadecenyl group.

Examples of the aryl group include such an aryl group as a phenyl group and a naphthyl group. Examples of the alkylaryl group include an alkylaryl group having from 7 to 18 carbon atoms (in which the alkyl group may be linear or branched, and may be substituted on the aryl group at an arbitrary position), such as a tolyl group, a xylyl group, an ethylphenyl group, a propylphenyl group, a butylphenyl group, a pentylphenyl group, a hexylphenyl group, a heptylphenyl group, an octylphenyl group, a nonylphenyl group, a decylphenyl group, an undecylphenyl group, and a dodecylphenyl group.

Examples of the arylalkyl group include an arylalkyl group having from 7 to 12 carbon atoms (in which the alkyl group maybe linear or branched), such as a benzyl group, a phenylethyl group, a phenylpropyl group, a phenylbutyl group, a phenylpentyl group, and a phenylhexyl group.

The hydrocarbon group having from 1 to 30 carbon atoms represented by R¹¹to R¹⁶ is preferably an alkyl group having from 1 to 30 carbon atoms or an aryl group having from 6 to 24 carbon atoms, and more preferably an alkyl group having from 3 to 18 carbon atoms or an aryl group having from 3 to 18 carbon atoms.

In the general formula (1), it is preferred that at least two of X¹ to X³ represent oxygen atoms, and it is more preferred that all three thereof represent oxygen atoms.

In the general formula (2), it is preferred that at least two of X⁴ to X⁷ represent oxygen atoms, it is more preferred that at least three thereof represent oxygen atoms, and it is particularly preferred that all thereof represent oxygen atoms.

In the general formula (2), it is preferred that all X⁴, X⁵, X⁶, and X⁷ represent oxygen atoms, and at least one of R¹⁴, R¹⁵, and R¹⁶ represents a hydrocarbon group having from 1 to 30 carbon atoms, and it is more preferred that all X⁴, X⁵, X⁶, and X⁷ represent oxygen atoms, and at least one of R¹⁴, R¹⁵, and R¹⁶ represents a branched hydrocarbon group having from 8 to 30 carbon atoms.

Examples of the phosphorus compound represented by the general formula (1) include the following phosphorus compounds.

Examples thereof include phosphorous acid, monothiophosphorous acid, dithiophosphorous acid; a phosphite monoester, a monothiophosphite monoester, and a dithiophosphite monoester, which each have one of the hydrocarbon group having from 1 to 30 carbon atoms; a phosphite diester, a monothiophosphite diester, and a dithiophosphite diester, which each have two of the hydrocarbon group having from 1 to 30 carbon atoms; a phosphite triester, a monothiophosphite triester, and a dithiophosphite triester, which each have three of the hydrocarbon group having from 1 to 30 carbon atoms; and mixtures thereof.

Examples of the phosphorus compound represented by the general formula (2) include the following phosphorus compounds.

Examples thereof include phosphoric acid, monothiophosphoric acid, dithiophosphoric acid, and trithiophosphoric acid; a phosphate monoester, a monothiophosphate monoester, a dithiophosphate monoester, and a trithiophosphate monoester, which each have one of the hydrocarbon group having from 1 to 30 carbon atoms; a phosphate diester, a monothiophosphate diester, a dithiophosphate diester, and a trithiophosphate diester, which each have two of the hydrocarbon group having from 1 to 30 carbon atoms; a phosphate triester, a monothiophosphate triester, a dithiophosphate triester, and a trithiophosphate triester, which each have three of the hydrocarbon group having from 1 to 30 carbon atoms; and mixtures thereof.

Examples of the salt of the phosphorus compound represented by the general formula (1) or (2) include a salt obtained in such a manner that the phosphorus compound is reacted with a metal base, such as a metal oxide, a metal hydroxide, and a metal carbonate, ammonia, and a nitrogen compound, such as an amine compound having only a hydrocarbon group having from 1 to 30 carbon atoms or a hydroxyl group-containing hydrocarbon group, so as to neutralize a part or the whole of the remaining acidic hydrogen.

Specific examples of the metal in the metal base include an alkali metal, such as lithium, sodium, potassium, and cesium, an alkaline earth metal, such as calcium, magnesium, and barium, and a heavy metal, such as zinc, copper, iron, lead, nickel, silver, manganese, and molybdenum.

Specific examples of the nitrogen compound include ammonia, a monoamine, a diamine, and a polyamine.

More specifically, examples thereof include an alkylamine having an alkyl group having from 1 to 30 carbon atoms (in which the alkyl group may be linear or branched), such as methylamine, ethylamine, propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, dimethylamine, diethylamine, dipropylamine, dibutylamine, dipentylamine, dihexylamine, diheptylamine, dioctylamine, dinonylamine, didecylamine, diundecylamine, didodecylamine, ditridecylamine, ditetradecylamine, dipentadecylamine, dihexadecylamine, diheptadecylamine, dioctadecylamine, methylethylamine, methylpropylamine, methylbutylamine, ethylpropylamine, ethylbutylamine, and propylbutylamine; an alkenylamine having an alkenyl group having from 2 to 30 carbon atoms (in which the alkenyl group maybe linear or branched), such as ethenylamine, propenylamine, butenylamine, octenylamine, and oleylamine; an alkanolamine having an alkanol group having from 1 to 30 carbon atoms (in which the alkanol group may be linear or branched), such as methanolamine, ethanolamine, propanolamine, butanolamine, pentanolamine, hexanolamine, heptanolamine, octanolamine, nonanolamine, methanolethanolamine, methanolpropanolamine, methanolbutanolamine, ethanolpropanolamine, ethanolbutanolamine, and propanolbutanolamine; an alkylenediamine having an alkylene group having from 1 to 30 carbon atoms, such as methylenediamine, ethylenediamine, propylenediamine, and butylenediamine; a polyamine, such as diethylenetriamine, triethylenetetramine, tetraethylenepentamine, and pentaethylenehexamine ; a compound having the monoamine, the diamine, or the polyamine having an alkyl group or an alkenyl group having from 8 to 20 carbon atoms, such as undecyldiethylamine, undecyldiethanolamine, dodecyldipropanolamine, oleyldiethanolamine, oleylpropylenediamine, and stearyltetraethylenepentamine, and a heterocyclic compound, such as N-hydroxyethyloleylimidazoline; alkylene oxide adducts of these compounds; and mixtures thereof.

The component (b) maybe used solely, or two or more kinds thereof may be arbitrarily mixed.

The phosphorus compound mixed in the surface protective agent composition of the invention is preferably a salt obtained in such a manner that the phosphorus compound is reacted with a metal base, such as a metal oxide, a metal hydroxide, and a metal carbonate, so as to neutralize a part or the whole of the remaining acidic hydrogen (i.e., a metal salt), in which it is more preferred that the metal in the metal base is one of an alkali metal, an alkaline earth metal, aluminum, titanium, and zinc, and it is particularly preferred that the metal in the metal base is one of calcium, magnesium, and zinc.

In the surface protective agent composition of the invention, the amount of the component (b) mixed is 0.005% by mass or more, preferably 0.01% by mass or more, and particularly preferably 0.1% by mass or more, and the content thereof is 4% by mass or less, all in terms of phosphorus element based on the total amount of the composition. When the content of the component (b) is less than 0.005% by mass in terms of phosphorus element, the effect of protecting a metal surface may be poor, whereas when the content exceeds 4% by mass, the effect of protecting a metal surface corresponding to the mixed amount may not be obtained, and thus both the cases are not preferred.

The surface protective agent composition of the invention contains (c) an amide compound (which may hereinafter referred to as a component (c)).

The component (c) used is an amide compound having one or more amide group (—NH—CO—), and is preferably a monoamide compound having one amide group represented by the following formula (3) or a bisamide compound represented by the following formula (4) or (5).

R²¹—CO—NH—R²² (3)

R²³—CO—NH—Y³¹—NH—CO—R²⁴ (4)

R²⁵—NH—CO—Y³²—CO—NH—R²⁶ (5)

In the general formulae (3) to (5), R²¹, R²², R²³, R²⁴, R²⁵, and R²⁶ each independently represent a saturated or unsaturated chain hydrocarbon group having from 5 to 25 carbon atoms, provided that R²² may be a hydrogen atom; and Y³¹ and Y³² each represent a divalent hydrocarbon group having from 1 to 10 carbon atoms selected from the group consisting of an alkylene group having from 1 to 10 carbon atoms, a phenylene group, and an alkylphenylene group having from 7 to 10 carbon atoms.

The monoamide compound is represented by the formula (3), and a part of hydrogen of the hydrocarbon group constituting R²¹ and R²² may be substituted by a hydroxyl group (—OH). Specific examples of this type of the monoamide compound include a saturated fatty acid amide, such as lauric acid amide, palmitic acid amide, stearic acid amide, behenic acid amide, and hydroxystearic acid amide, an unsaturated fatty acid amide, such as oleic acid amide and erucic acid amide, and a substituted amide compound containing a saturated or unsaturated long-chain fatty acid and a long-chain amine, such as stearylstearic acid amide, oleyloleic acid amide, oleylstearic acid amide, and stearyloleic acid amide.

In the amide compound, an amide compound, in which R²¹ and R²² in the formula (3) each independently represent a saturated chain hydrocarbon group having from 12 to 20 carbon atoms, or R²² represents hydrogen, and/or an amide compound, in which at least one of R²¹ and R²² represents an unsaturated chain hydrocarbon group having from 12 to 20 carbon atoms are preferred, and specifically stearylstearic acid amide is preferred.

The bisamide compound is represented by the formula (4) or (5) in the form of an acid amide of a diamine or an acid amide of a dibasic acid. In the formulae (4) and (5), in each of the hydrocarbon groups represented by R²³, R²⁴, R²⁵, R²⁶, Y³¹, and Y³², a part of hydrogen may be substituted by a hydroxyl group (—OH).

Specific examples of the bisamide compound represented by the formula (4) include ethylenebisstearic acid amide, ethylenebisisostearic acid amide, ethylenebisoleic acid amide, methylenebislauric acid amide, hexamethylenebisoleic acid amide, hexamethylenebishydroxystearic acid amide, and m-xylylenebisstearic acid amide. Specific examples of the amide compound represented by the formula (5) include N,N′-distearylsebacic acid amide.

In the bisamide compound, as similar to the case of the monoamide compound, an amide compound, in which R²³ and R²⁴ in the formula (4) and R²⁵ and R²⁶ in the formula (5) each independently represent a saturated chain hydrocarbon group having from 12 to 20 carbon atoms, and/or an amide compound, in which at least one of R²³ and R²⁴, or at least one of R²⁵ and R26 represents an unsaturated chain hydrocarbon group having from 12 to 20 carbon atoms are preferred, and examples of the compound include ethylenebisstearic acid amide.

The component (c) maybe used solely, or two or more kinds thereof may be arbitrarily mixed.

When the amide compound is mixed with the lubricant base oil in the form of liquid, a composition in the form of gel at ordinary temperature is formed. That is, the amide compound functions as a semi-solidifying compound that semi-solidifies (makes gel) the lubricant base oil in the form of liquid, at ordinary temperature. Taking the points into consideration that the surface protective agent for a metal is in a semi-solid state at ordinary temperature, at which the surface protective agent functions, and that the surface protective agent is used in the form of liquid in a coating operation at a high temperature so that the surface protective layer can be uniformly formed on the metal surface, the melting point of the amide compound mixed in the surface protective agent composition of the invention is preferably from 20 to 200° C., more preferably from 80 to 180° C., and particularly preferably from 120 to 150° C. The molecular weight of the amide compound is preferably from 100 to 1,000, and more preferably from 150 to 800.

In the surface protective agent composition of the invention, the amount of the component (c) mixed is 0.1% by mass or more, preferably 1% by mass or more, and more preferably 5% by mass or more, based on the total amount of the composition. The amount thereof mixed is 40% by mass or less, preferably 30% by mass or less, and more preferably 20% by mass or less. In the case where the amount of the component (c) mixed is less than 0.1% by mass, a gelled composition cannot be formed at ordinary temperature, whereas the amount exceeds 40% by mass, the surface protective agent composition has poor handleability, and thus both the cases are not preferred.

In the case where the component (b) neither contains the metal salt of the phosphorus compound represented by the general formula (1) nor the metal salt of the phosphorus compound represented by the general formula (2), the surface protective agent composition further contains (d) a salicylate of an alkali metal or an alkaline earth metal having an alkyl group or an alkenyl group having from 10 to 40 carbon atoms, and/or a basic (or perbasic) salt thereof (which may be hereinafter referred to as a component (d)).

In the case where the component (b) contains the metal salt of the phosphorus compound represented by the general formula (1) or the metal salt of the phosphorus compound represented by the general formula (2), the surface protective agent composition preferably further contains the component (d).

Examples of the alkali metal or the alkaline earth metal of the component (d) include sodium, potassium, magnesium, barium, and calcium, and calcium is particularly preferably used.

Examples of the alkyl group having from 10 to 40 carbon atoms include a decyl group, an undecyl group, a dodecyl group, a tridecyl group, a tetradecyl group, a pentadecyl group, a hexadecyl group, a heptadecyl group, and an octadecyl group (which may be linear or branched).

Examples of the alkenyl group having from 10 to 40 carbon atoms include a decenyl group, an undecenyl group, a dodecenyl group, a tridecenyl group, a tetradecenyl group, a pentadecenyl group, a hexadecenyl group, a heptadecenyl group, and an octadecenyl group (which may be linear or branched and may have the double bond at an arbitrary position).

The production method of the component (d) is not particularly limited, and a known production method of a monoalkyl salicylate may be used. For example, phenol as a starting material is alkylated with an equivalent amount of an olefin having from 10 to 40 carbon atoms, and then a monoalkylsalicylic acid obtained through carboxylation with carbon dioxide gas or the like, a monoalkylsalicylic acid obtained by alkylating salicylic acid as a starting material with an equivalent amount of the aforementioned olefin, or the like is reacted with a metal base, such as an oxide or a hydroxide of an alkali metal or an alkaline earth metal, or is once formed into an alkali metal salt, such as a sodium salt or a potassium salt, and then subjected to substitution with an alkaline earth metal salt.

The component (d) in the invention includes a basic salt obtained in such a manner that the salicylate of an alkali metal or an alkaline earth metal obtained above (neutral salt) and an excessive amount of an alkali metal or alkaline earth metal salt or an alkali metal or alkaline earth metal base (such as a hydroxide and an oxide of an alkali metal or an alkaline earth metal) are heated in the presence of water, and a perbasic salt obtained in such a manner that the neutral salt and a base, such as a hydroxide of an alkali metal or an alkaline earth metal, are reacted in the presence of carbon dioxide gas, boric acid, or a borate salt.

The component (d) used in the invention is preferably the basic (or perbasic) salt, and the metal ratio of the inorganic compound, such as calcium carbonate, constituting the component (d) with respect to the organic compound is preferably from 1 to 7.5, more preferably from 1 to 5, and further preferably from 1 to 3.5. The metal ratio herein is shown by the expression (valence number of metal element of basic (or perbasic) salt)×(content of metal element (mol %))/(content of soap group (mol %)), the metal element means calcium, magnesium, and the like, and the soap group means a salicylic acid group and the like.

The component (d) may be used solely, or two or more kinds thereof may be arbitrarily mixed.

In the surface protective agent composition of the invention, the amount of the component (d) mixed is preferably 0.005% by mass or more, and the content thereof is preferably 3.0% by mass or less, in terms of metal element based on the total amount of the composition. When the content of the component (d) is in the range, the effect of protecting a metal surface may be further favorably exhibited.

The surface protective agent composition of the invention preferably further contains (e) a metal deactivator having a nitrogen-containing heterocyclic ring in the molecule thereof (which may be hereinafter referred to as a component (e)), for enhancing the effect of protecting a metal surface.

The component (e) used may be one that is ordinarily used in a lubricant oil and the like, and any one of a benzotriazole-based compound, a tolyltriazole-based compound, a benzothiazole-based compound, a thiadiazole-based compound, and an imidazole-based compound is preferably used. The metal deactivator mixed in the surface protective agent composition of the invention is preferably one having a hydrocarbon group having 4 or more carbon atoms, which is excellent in dissolution stability of the surface protective agent composition, and is more preferably one having a linear or branched hydrocarbon group having 8 or more carbon atoms, which is excellent in the formation capability of the metal surface protective film formed with the surface protective agent composition.

The metal deactivator may be used solely, or two or more kinds thereof may be arbitrarily mixed.

The amount of the metal deactivator mixed in the surface protective agent composition of the invention is preferably 0.01% by mass or more, more preferably 0.1% by mass or more, and particularly preferably 0.2% by mass or more, based on the total amount of the composition. The amount thereof mixed is preferably 30% by mass or less, more preferably 25% by mass or less, and particularly preferably 20% by mass or less. When the amount of the metal deactivator mixed is in the range, the effect of protecting a metal surface may be further favorably exhibited.

The surface protective agent composition of the invention preferably further contains (f) an antioxidant (which may be hereinafter referred to as a component (f)), for enhancing the heat and oxidation stability of the composition.

The component (f) used may be one that is ordinarily used in a lubricant oil, such as a phenol-based compound and an amine-based compound. Among them, alkylphenol compounds and bisphenol compounds, such as hindered phenol compounds, are preferred.

Specific examples thereof include alkylphenol compounds, such as 2,6-di-tert-butyl-4-methylphenol, bisphenol compounds, such as methylene-4,4-bisphenol (2,6-di-tert-butyl-4-methylphenol), naphthylamine compounds, such as phenyl-α-naphthylamine, dialkyldiphenylamine compounds, zinc dialkyldithiophosphate compounds, such as zinc di-2-ethylhexyldithiophosphate, and an ester of a (3,5-di-tert-butyl-4-hydroxyphenyl) fatty acid (such as propionic acid) and a monohydric or polyhydric alcohol, such as methanol, octadecanol, 1,6-hexanediol, neopentyl glycol, thiodiethylene glycol, triethylene glycol, and pentaerythritol.

One kind or two or more kinds of antioxidants arbitrarily selected therefrom may be mixed in an arbitrary amount, and the content thereof is generally preferably from 0.01 to 5.0% by mass based on the total amount of the composition.

The surface protective agent composition of the invention preferably further contains a thickener (which may be hereinafter referred to as a component (g)), for enhancing the surface protection capability of the composition.

Specific examples of the component (g) include a so-called non-dispersive viscosity index enhancer, such as a copolymer of one kind or two or more kinds of monomers selected from various methacrylate esters, such as a polyalkyl methacrylate, and a hydrogenated product thereof, and a so-called dispersive viscosity index enhancer, which may be obtained by further copolymerizing various methacrylate esters containing a nitrogen compound. Specific examples of other viscosity index enhancers include a non-dispersive or dispersive ethylene-a-olefin copolymer (examples of the α-olefin include propylene, 1-butene, and 1-pentene) and a hydrogenated product thereof, polyisobutylene and a hydrogenated product thereof, a styrene-diene hydrogenated copolymer, a styrene-maleic anhydride ester copolymer, and a polyalkylstyrene. Among these, a polyalkyl methacrylate, an ethylene-α-olefin copolymer and a hydrogenated product thereof, and polyisobutylene and a hydrogenated product thereof are preferred.

One kind or two or more kinds of thickeners selected therefrom may be mixed in an arbitrary amount, and the content thereof is generally preferably from 0.1 to 20% by mass based on the total amount of the composition.

The surface protective agent composition of the invention preferably further contains grease (which may be hereinafter referred to as a component (h)), for enhancing the surface protection capability of the composition.

Specific examples of the component (h) include metal soap grease and urea grease each containing a mineral oil and/or a poly-α-olefin or a fatty acid ester as a base oil, and a metal soap or a urea compound as a thickener. Examples of the metal soap-based thickener include a simple soap and a complex soap. The simple soap is a metal soap obtained by saponifying a fatty acid or a fat with an alkali metal hydroxide, an alkaline earth metal hydroxide or the like. The complex soap is formed by combining the fatty acid used in the simple soap with an organic acid having a different molecular structure. The fatty acid may be a fatty acid derivative having a hydroxyl group or the like. While the fatty acid may be an aliphatic carboxylic acid, such as stearic acid, or an aromatic carboxylic acid, such as terephthalic acid, a monobasic or dibasic aliphatic carboxylic acid, particularly an aliphatic carboxylic acid having from 6 to 20 carbon atoms, may be used, and particularly a monobasic aliphatic carboxylic acid having from 12 to 20 carbon atoms and a dibasic aliphatic carboxylic acid having from 6 to 14 carbon atoms are preferably used. A monobasic aliphatic carboxylic acid having one hydroxyl group is preferred. Examples of the preferred organic acid to be combined for the complex soap include acetic acid, a dibasic acid, such as azelaic acid and sebacic acid, and benzoic acid.

Examples of the metal of the metal soap-based thickener include an alkali metal, such as lithium and sodium, an alkaline earth metal, such as calcium, and an amphoteric metal, such as aluminum, and an alkali metal, particularly lithium, is preferably used.

The carboxylate metal salt may be used solely, or two or more kinds thereof may be arbitrarily mixed. The content of the metal soap-based thickener may be such an amount that provide an intended consistency, and for example, is preferably from 2 to 30% by mass, and more preferably from 3 to 20% by mass, based on the total amount of the grease composition.

Examples of the urea-based thickener include a diurea compound obtained through a reaction of a diisocyanate with a monoamine, and a polyurea compound obtained through a diisocyanate with a monoamine and a diamine.

Examples of the diisocyanate include an aliphatic diisocyanate and an aromatic diisocyanate. Examples of the aliphatic diisocyanate include a diisocyanate having a saturated and/or unsaturated linear, branched, or alicyclic hydrocarbon group. Preferred examples thereof include phenylene diisocyanate, tolylene diisocyanate, diphenyl diisocyanate, diphenylmethane diisocyanate, octadecane diisocyanate, decane diisocyanate, and hexane diisocyanate. Examples of the monoamine include an aliphatic monoamine and an aromatic monoamine. Examples of the aliphatic monoamine include a monoamine having a saturated and/or unsaturated linear, branched, or alicyclic hydrocarbon group. Preferred examples thereof include octylamine, dodecylamine, hexadecylamine, stearylamine, oleylamine, aniline, p-toluidine, and cyclohexylamine. Examples of the diamine include an aliphatic diamine and an aromatic diamine. Examples of the aliphatic diamine include a diamine having a saturated and/or unsaturated linear, branched, or alicyclic hydrocarbon group. Preferred examples thereof include ethylenediamine, propanediamine, butanediamine, hexanediamine, octanediamine, phenylenediamine, tolylenediamine, xylenediamine, and diaminodiphenylmethane.

The urea-based thickener may be used solely, or two or more kinds thereof may be arbitrarily mixed. The content of the thickener may be such an amount that provide an intended consistency, and for example, is preferably from 2 to 30% by mass, and more preferably from 3 to 20% by mass, based on the total amount of the grease composition.

One or two or more kinds of the grease selected therefrom may be mixed in an arbitrary amount. In general, the content thereof is preferably from 0.1 to 10% by mass based on the total amount of the composition.

The surface protective agent composition of the invention preferably further contains a dye (which may be hereinafter referred to as a component (i)), for enhancing the visibility of the coated state thereof.

The component (i) capable of being mixed in the surface protective agent of the invention is an arbitrary component, and may be a commercially available product, which may be mixed in an arbitrary amount. In general, the amount thereof mixed is preferably 0.0001% by mass or more and 1.0% by mass or less based on the total amount of the composition. The component (i) is more preferably a fluorescent dye for further enhancing the visibility of the coated state.

The surface protective agent composition of the invention may further contain at least one of a detergent selected from the group consisting of a sulfonate metal detergent and a phenate metal detergent, for neutralizing acid generated by degradation of the composition.

The surface protective agent composition of the invention preferably has a melting point of from 120 to 150° C.

In the electric connection structure containing the first metal member and the second metal member of the invention, a surface protective layer is formed by coating the surface protective agent composition on at least the first metal member.

According to the invention, the surface protective layer formed by coating the surface protective agent composition is stably retained on the surface of the first metal member, and therefore even, for example, in the case where water (particularly an aqueous solution containing an ion, such as chloride) is attached over copper or copper alloy (which may be hereinafter referred to as “copper (alloy)”) and a tin plated layer contained in the first metal member, and in the case where water (particularly an aqueous solution containing an ion, such as chloride) is attached over the first metal member and the second metal member, corrosion current can be suppressed from flowing therebetween. According to the invention, consequently, in an electric connection structure containing a metal member, the metal member can be suppressed from corrosion.

The second metal member may be formed of a metal material that has a larger ionization tendency than the first metal member. In this constitution, the metal members can be effectively suppressed from corrosion, for example, in the case where the first metal member is copper (alloy), and the second metal member is formed of aluminum or aluminum alloy (which may be hereinafter referred to as “aluminum (alloy)”).

The first metal member may be a first terminal, whereas the second metal member may be a core wire of a wire that is electrically connected to the first terminal. In this constitution, the metal members can be prevented from corrosion in the connection structure containing a terminal formed of copper and a wire having a core wire formed of aluminum (alloy). For example, in a wire harness for an automobile, which is used under a severe environment at various temperature ranges under influence of water, aluminum (alloy) having reduced weight can be used as the core wire, and the wire harness can be effectively utilized for weight reduction of an automobile, i.e., reduction of the fuel consumption.

Furthermore, the first metal member and the second metal member may be formed of the same metal material, and for example, in the case where both the first metal member and the second metal member are members formed of copper (alloy), the metal members can be effectively suppressed from corrosion. Examples of the second metal member formed of copper (alloy) include a copper (alloy) wire.

The first metal member may be a first terminal, whereas the second metal member may be a second terminal that is engaged with the first terminal. In this constitution, the metal members can be prevented from corrosion in the connection structure of the first terminal and the second terminal, and leak current can be suppressed from flowing between the terminals.

The surface protective agent composition of the invention is preferably in a semi-solid state (a gelled state) in a general use temperature range, in which the surface protective agent composition is demanded to function as a surface protective layer, and is preferably in a liquid state in a coating process. According to the constitution, the surface protective layer may be prevented from flowing out from the surface of the metal member in the general use temperature range, so as to maintain the corrosion suppressing function, and the surface protective layer can be easily removed by crimping or sliding at the electric connection portion in the case where the first metal member is an electric terminal, so as to enhance the reliability of the electric connection. Furthermore, by coating the composition at the melting point, at which the composition changes from a semi-solid state to a liquid state, or higher, the operation of the coating process may be facilitated, and the surface protective layer can be formed uniformly.

### Embodiment 1

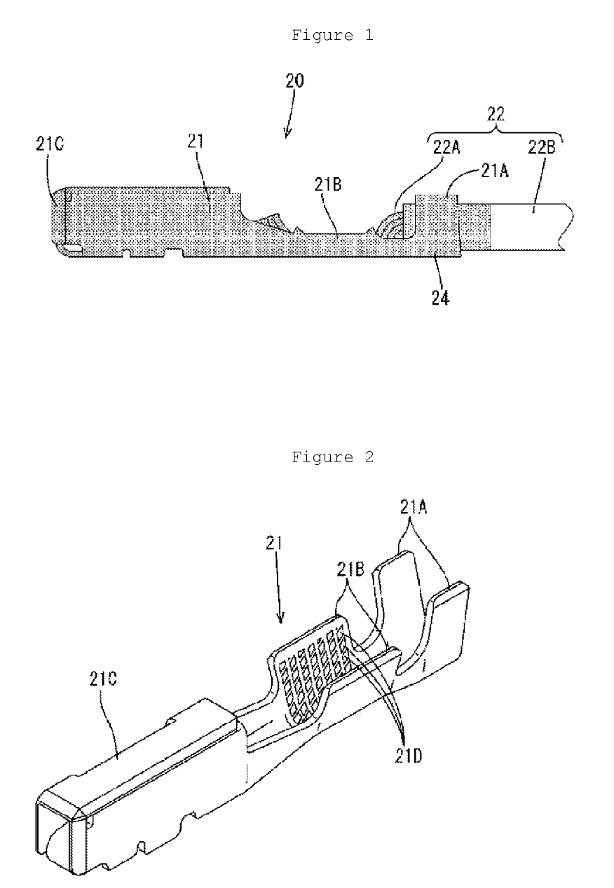

An electric connection structure 20 according to an embodiment 1 of the invention will be described with reference to FIGS. 1 to 3. The embodiment is an electric connection structure 20 containing a terminal 21 containing copper or copper alloy (which is an example of the first metal member), and a wire 22 having a core wire 22A containing a metal having a larger ionization tendency than copper (which is an example of the second metal member).

### Wire 22

The wire 22 contains the core wire 22A having surrounded thereon by insulation coating 22B formed of a synthetic resin. The metal constituting the core wire 22A may be a metal that has a larger ionization tendency than copper, and examples thereof include magnesium, aluminum, manganese, zinc, chromium, iron, cadmium, cobalt, nickel, tin, lead, and alloy thereof. In this embodiment, the core wire 22A contains aluminum or aluminum alloy.

The core wire 22A in this embodiment is a twisted wire containing plural metal thin wires twisted with each other. The core wire 22A used may be a so-called single core wire formed of a metal bar. Aluminum or aluminum alloy has relatively small specific gravity and thus can reduce the total weight of the wire having a terminal 20.

### Terminal 21

As shown in FIG. 1, the terminal 21 has a wire barrel 21B that is connected to the core wire 22A exposed from the end of the wire 22, an insulation barrel 21A that is formed in the rear of the wire barrel 21B and retains the insulation coating 22B, and a body 21C that is formed in front of the wire barrel 21B and is to receive a tab of a male terminal (which is not shown in the figure) inserted thereinto.

As shown in FIG. 2, the region of the terminal 21 that is to be connected to the core wire 22A exposed from the end of the wire 22 has plural depressions 21D formed thereon. On crimping the wire barrel 21B with the core wire 22A, the edges formed on the peripheral portions of the depressions 21D are slidingly in contact with the surface of the core wire 22A and strip the oxidized coating formed on the surface of the core wire 22A. According thereto, the metal surface of the core wire 22A is exposed, and the metal surface is in contact with the wire barrel 21B, so as to connect electrically the core wire 22A and the wire barrel 21B (i.e., the terminal 21).

The terminal 21 is formed of a metal plate of copper or copper alloy having been pressed into a prescribed shape. A tin plated layer (which is not shown in the figure) is formed on the front surface and the back surface of the terminal 21. The tin plated layer has a function of reducing the contact resistance between the core wire 22A and the wire barrel 21B.

On the end surface of the terminal 21, no tin plated layer is formed, and the plate containing copper or copper alloy is exposed.

### Surface Protective Layer 24

In this embodiment shown in FIG. 1, a surface protective layer 24 is formed on the entire surface of the terminal 21. In FIG. 1, the surface protective layer 24 is shown by a shaded pattern. Specifically, the surface protective layer 24 is formed by coating the surface protective agent composition of the invention on the surface of the terminal 21 including the end surface of the terminal 21 (at least the end surface of the wire barrel 21B The coating method of the surface protective agent composition for achieving the embodiment may be easily performed by coating the surface protective agent composition on the terminal 21 before connecting to the wire 22 by such means as dipping, spraying, or brash coating, followed by connecting to the wire 22.

Furthermore, as shown in FIG. 1(b), the surface protective agent composition may be formed on the entire surface of the terminal 21 and the wire 22 connected thereto. In this case, it may be easily achieved by coating the surface protective agent composition on the entire of the wire having the terminal 20 containing the terminal 21 having the wire 22 connected thereto, by such means as dipping, spraying, or brash coating.

In the front and rear of the wire barrel 21B, the core wire 22A is exposed from the wire barrel 21B, and the surface protective layer 24 is also formed on the surface of the core wire 22A.

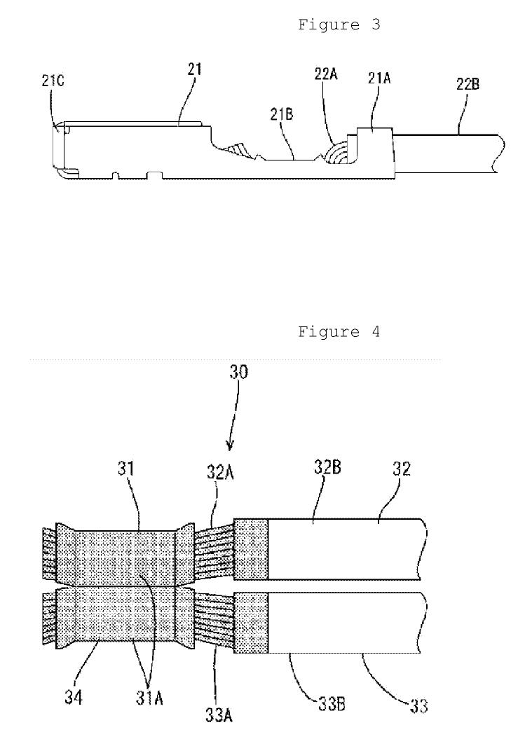

In this embodiment, the surface protective layer 24 may be formed, for example, in such a manner that the wire 22 and the terminal 21 are crimped to make the state shown in FIG. 3, and then at least the terminal 21 and the core wire 22A exposed from the wire 22 are dipped in the surface protective agent composition in a liquid state by heating to the melting point or higher, followed by withdrawing therefrom.

In the electric connection structure 20 containing the terminal 21 and the wire 22 of the embodiment, the terminal 21 containing copper (alloy) having formed thereon a tin plated layer has the surface protective layer 24 formed by coating the surface protective agent composition. According to the embodiment, therefore, the surface protective layer 24 is stably retained on the surface of the terminal 21, and thus even in the case where water (particularly an aqueous solution containing an ion, such as chloride) is attached over the portion of the terminal 21 having no tin plated layer formed thereon and the tin plated layer, and in the case where water (particularly an aqueous solution containing an ion, such as chloride) is attached over the terminal 21 and the wire 22, corrosion current can be suppressed from flowing therebetween, thereby suppressing the terminal 21 and the wire 22 from corrosion in the electric connection structure 20 containing the terminal 21 and the wire 22.

### Embodiment 2

An electric connection structure 30 according to an embodiment 2 of the invention will be described with reference to FIG. 4. This embodiment is a structure, in which a copper wire 32 having a copper core wire 32A containing copper or copper alloy (which is an example of the second metal member) and an aluminum wire 33 having an aluminum core wire 33A containing aluminum or aluminum alloy (which is another example of the second metal member) are connected to each other with a splicing terminal 31. The outer periphery of the copper core wire 32A is coated with an insulation coating 32B formed of a synthetic resin, and the outer periphery of the aluminum core wire 33A is coated with an insulation coating 33B formed of a synthetic resin. The descriptions that are common to the embodiment 1 are omitted.

In this embodiment, the copper core wire 32A and the aluminum core wire 33A are electrically connected with the splicing terminal 31. The splicing terminal 31 has a wire barrel 31A that is crimped by wrapping on both the copper core wire 32A and the aluminum core wire 33A. The splicing terminal 31 (which is an example of the first metal member) is formed of a plate containing copper or copper alloy and has formed on the surface thereof a tin plated layer (which is not shown in the figure), but no tin plated layer is formed on the end surface thereof.

After connecting the copper core wire 32A and the aluminum core wire 33A to the splicing terminal 31, they may be dipped in the surface protective agent composition in a liquid state by heating to a gelation point or higher, and then withdrawn therefrom, so as to form a surface protective layer.

In this embodiment, as shown in FIG. 4, the surface protective layer 34 is formed at least the surface of the splicing terminal 31 including the end surface thereof, and the surface of the portions of the copper core wire 32A and the aluminum core wire 33A that are exposed from the splicing terminal 31. In FIG. 4, the surface protective layer 34 is shown by a shaded pattern.

In this embodiment, as similar to the embodiment 1, the surface protective layer 34 formed by coating the surface protective agent composition containing a compound having metal affinity and a base oil is formed on the splicing terminal 31 containing copper (alloy) having a tin plated layer formed thereon in the electric connection structure 30 of the splicing terminal 31 and the two kinds of wires 32 and 33. In this embodiment, accordingly, the splicing terminal 31 and the wires 32 and 33 can be suppressed from corrosion.

### EXAMPLE

The contents of the invention will be described more specifically with reference to examples and comparative examples, but the invention is not limited to the examples. The following examples are based on the embodiment 1 (Fig. (b)).

### Surface Protective Agent Composition

The surface protective agent compositions according to the invention (Examples 1 to 4) and the compositions for comparison (Comparative Examples 1 to 4) were prepared according to the formulation shown in Table 1.

TABLE 1

| | | | | | | | Comp. | Comp. | Comp. | Comp. | |
|---|---|---|---|---|---|---|---|---|---|---|---|
| | | | Example | Example | Example | Example | Example | Example | Example | Example | |
| | | | 1 | 2 | 3 | 4 | 1 | 2 | 3 | 4 | Untreated |
| Component (a) | (a-1) | mass % | | | | | 94. 9 | | | | |
| | (a-2) | mass % | 34 | | | 59 | | 39 | 54 | 67.5 | |
| | (a-3) | mass % | | 24 | 24 | | 4.9 | | | | |
| Component (b) | (b-1) | mass % | 20 | | | | | | | | |
| | (b-2) | mass % | | | 20 | | | | | | |
| | (b-3) | mass % | | 30 | | 20 | | 30 | | | |
| Component (c) | (c-1) | mass % | 15 | 15 | 15 | 15 | | | 15 | 18.75 | |
| Component (e) | (e-1) | mass % | 20 | 20 | 30 | | | 20 | 20 | | |
| Component (f) | (f-1) | mass % | | | | | 0.2 | | | | |
| | (f-2) | mass % | 1 | 1 | 1 | 1 | | 1 | 1 | 1.25 | |
| Component (g) | (g-1) | mass % | 10 | 5 | 5 | 5 | | 10 | 10 | 12.5 | |
| Component (h) | (h-1) | mass % | | 5 | 5 | | | | | | |

| | | | | | | | | | | |
|---|---|---|---|---|---|---|---|---|---|---|
| Corrosion | Initial stage | 12 | 3 | 10 | 14 | 46 | 5 | 25 | 35 | 50 |
| current | | | | | | | | | | |
| (μA/terminal) | After leaving at | 15 | 14 | 13 | 17 | 49 | 40 | 37 | 45 | 52 |
| | 120° C., 168 hours | | | | | | | | | |
| Evaluation of | Initial stage | A | A | A | A | F | A | C | D | F |
| corrosion of | | | | | | | | | | |
| terminal | | | | | | | | | | |
| (Appearance) | After leaving at | A | A | A | A | F | F | D | F | F |
| | 120° C., 168 hours | | | | | | | | | |

(a-1) mineral base oil, kinematic viscosity (100° C.): 4.0 mm²/s, % Cₚ: 66.9%
(a-2) mineral base oil, kinematic viscosity (100° C.): 11.1 mm²/s, % Cₚ: 66.1%
(a-3) mineral base oil, kinematic viscosity (100° C.): 32.0 mm²/s, % Cₚ: 66.9%
(b-1) Zn salt of 2-ethylhexyl phosphate, P content: 7.2% by mass
(b-2) Zn salt of isostearylphosphate, P content: 6.0% by mass
(b-3) Ca salt of isostearylphosphate, P content: 6.2% by mass
(c-1) ethylenebisstearic acid amide
(e-1) benzotriazole derivative
(f-1) thiobisphenol antioxidant
(f-2) hindered phenol antioxidant
(g-1) olefin copolymer, weight average molecular weight: 120,000
(h-1) lithium grease, consistency: 278

The surface protective agent compositions according to the invention (Examples 5 to 13) and the compositions for comparison (Comparative Examples 5 to 9) were prepared according to the formulation shown in Table 2.

TABLE 2

| | | | Example | Example | Example | Example | Example | Example | Example | Example |
|---|---|---|---|---|---|---|---|---|---|---|
| | | | 5 | 6 | 7 | 8 | 9 | 10 | 11 | 12 |
| Component (a) | (a-1) | mass % | 44 | 49 | | | 44 | 44 | 44 | 59 |
| | (a-2) | mass % | | | 44 | | | | | |
| | (a-3) | mass % | | | | 44 | | | | |
| Component (b) | (b-1) | mass % | | | | | | | | |
| | (b-4) | mass % | 9 | 9 | 9 | 9 | | | 6 | 9 |
| | (b-5) | mass % | | | | | 9 | | | |
| | (b-6) | mass % | | | | | | 9 | | |
| Component (c) | (c-1) | mass % | 30 | 30 | 30 | 30 | 30 | 30 | 30 | 15 |
| Component (d) | (d-1) | mass % | 11 | 11 | 11 | 11 | 11 | 11 | | 11 |
| | (d-2) | mass % | | | | | | | 14 | |
| Component (e) | (e-1) | mass % | | | | | | | | |
| Component (f) | (f-2) | mass % | 1 | 1 | 1 | 1 | 1 | 1 | 1 | 1 |
| Component (g) | (g-1) | mass % | 5 | | 5 | 5 | 5 | 5 | 5 | 5 |

| | | | | | | | | | |
|---|---|---|---|---|---|---|---|---|---|
| Phosphorus content | mass % | 0.6 | 0.6 | 0.6 | 0.6 | 0.6 | 0.8 | 0.4 | 0.6 |
| from Component (b) | | | | | | | | | |
| Metal content from | mass % | 0.9 | 0.9 | 0.9 | 0.9 | 0.9 | 0. 9 | 0.3 | 0.9 |
| Components (b) and | | | | | | | | | |
| (d) | | | | | | | | | |

| | | | | | | | | | |
|---|---|---|---|---|---|---|---|---|---|
| Corrosion | Initial stage | 8 | 10 | 7 | 4 | 15 | 20 | 19 | 12 |
| Current | | | | | | | | | |
| (μA/terminal) | After leaving | 9 | 11 | 10 | 9 | 20 | 25 | 22 | 25 |
| | at 120° C., | | | | | | | | |
| | 168 hours | | | | | | | | |
| Evaluation of | Initial stage | A | A | A | A | B | B | B | A |
| corrosion of | | | | | | | | | |
| terminal | | | | | | | | | |
| (Appearance) | After leaving | A | A | A | A | C | C | C | C |
| | at 120° C., | | | | | | | | |
| | 168 hours | | | | | | | | |

| | | | | Comp. | Comp. | Comp. | Comp. | Comp. | |
|---|---|---|---|---|---|---|---|---|---|
| | | | Example | Example | Example | Example | Example | Example | |
| | | | 13 | 5 | 6 | 7 | 8 | 9 | Untreated |
| Component (a) | (a-1) | mass % | | 94 | 64 | 55 | 53 | 74 | |
| | (a-2) | mass % | 28 | | | | | | |
| | (a-3) | mass % | | | | | | | |
| Component (b) | (b-1) | mass % | 20 | | | | | | |
| | (b-4) | mass % | | | | 9 | | 9 | |
| | (b-5) | mass % | | | | | | | |
| | (b-6) | mass % | | | | | | | |
| Component (c) | (c-1) | mass % | 15 | | 30 | 30 | 30 | | |
| Component (d) | (d-1) | mass % | 11 | | | | 11 | 11 | |
| | (d-2) | mass % | | | | | | | |
| Component (e) | (e-1) | mass % | 20 | | | | | | |
| Component (f) | (f-2) | mass % | 1 | 1 | 1 | 1 | 1 | 1 | |
| Component (g) | (g-1) | mass % | 5 | 5 | 5 | 5 | 5 | 5 | |

| | | | | | | | |
|---|---|---|---|---|---|---|---|
| Phosphorus content | mass % | 1.4 | 0 | 0 | 0.6 | 0 | 0.6 |
| from Component (b) | | | | | | | |
| Metal content from | mass % | 3.1 | 0 | 0 | 0 | 0.9 | 0.9 |
| Components (b) and | | | | | | | |
| (d) | | | | | | | |

| | | | | | | | | |
|---|---|---|---|---|---|---|---|---|
| Corrosion | Initial stage | 11 | 48 | 30 | 45 | 45 | 18 | 50 |
| Current | | | | | | | | |
| (μA/terminal) | After leaving | 14 | 53 | 42 | 48 | 47 | 49 | 52 |
| | at 120° C., | | | | | | | |
| | 168 hours | | | | | | | |
| Evaluation of | Initial stage | A | F | A | F | F | B | F |
| corrosion of | | | | | | | | |
| terminal | | | | | | | | |
| (Appearance) | After leaving | A | F | F | F | F | F | F |
| | at 120° C., | | | | | | | |
| | 168 hours | | | | | | | |

(a-1) mineral base oil, kinematic viscosity (100° C.): 4.0 mm²/s
(a-2) mineral base oil, kinematic viscosity (100° C.): 11.1 mm²/s
(a-3) mineral base oil, kinematic viscosity (100° C.): 32.0 mm²/s
(b-1) Zn salt of 2-ethylhexyl phosphate, P content: 7.2% by mass
(b-4) isostearyl acid phosphate, P content: 6.3% by mass
(b-5) oleyl acid phosphate, P content: 6.5% by mass
(b-6) di-2-ethylhexyl acid phosphate, P content: 9.4% by mass
(c-1) ethylenebisstearic acid amide
(d-1) calcium salicylate detergent having alkyl group having from 10 to 20 carbon atoms, Ca content: 8.0% by mass, metal ratio: 3.4
(d-2) calcium salicylate detergent having alkyl group having from 10 to 20 carbon atoms, Ca content: 2.3% by mass, metal ratio: 1.1
(e-1) benzotriazole derivative
(f-2) hindered phenol antioxidant
(g-1) olefin copolymer, weight average molecular weight: 120,000

### Evaluation

### Evaluation of Corrosion Current

A tin plated terminal (material: copper alloy) and a copper wire (copper voltage withstanding area: 0.75 mm²) were crimped with each other to form a copper wire-crimped terminal, which was then dipped (for 15 seconds) in the surface protective agent composition in a liquid state by heating to 150° C., and then withdrawn therefrom at a speed of 1 cm/sec, thereby producing a copper wire-crimped terminal having a surface protective layer. While the copper wire-crimped terminal thus treated and an aluminum plate (width: 1 cm, thickness: 0.2 mm) were immersed in 5% sodium chloride aqueous solution (the copper wire-crimped terminal was entirely immersed, and the aluminum plate was immersed by 1 cm from the tip end thereof), the copper wire of the copper wire-crimped terminal and the aluminum plate was shorted under heating to 50° C., and after 1 hour, the electric current flowing therebetween was measured.

For evaluating the heat resistance of the surface protective agent composition, the copper wire-crimped terminal having the surface protective layer produced above was subjected to the heat resistance evaluation condition according to JASO D618, i.e., left at 120° C. for 168 hours, and then the corrosion current was measured in the same manner as above (the corrosion current of the untreated copper wire-crimpled terminal measured in the aforementioned manner was 50 μA in the initial stage and after leaving at high temperature).

The results are shown in the lower columns of Tables 1 and 2.

### Evaluation of Corrosion of Aluminum Wire-crimped Terminal

A tin plated terminal (material: copper alloy) and an aluminum wire (copper voltage withstanding area: 0.75 mm²) were crimped with each other to form an aluminum wire-crimped terminal, which was dipped (for 15 seconds) in the surface protective agent composition in a liquid state by heating to 150° C., and then withdrawn therefrom at a speed of 1 cm/sec, thereby producing an aluminum wire-crimped terminal having a surface protective layer. While the aluminum wire-crimped terminal thus produced was subjected to a salt water spraying test according to JIS 22371 (spraying 5% salt water at 35° C.) for 168 hours, and then the corrosion state of the aluminum wire was confirmed according to the appearance grades shown in Table 3.

For evaluating the heat resistance of the surface protective agent composition, the aluminum wire-crimped terminal having the surface protective layer produced above was subjected to the heat resistance evaluation condition according to JASO D618, i.e., left at 120° C. for 168 hours, and then the corrosion state of the aluminum wire was confirmed according to the judgment standard shown in Table 3 in the same manner as above.

The results are shown in the lower columns of Tables 1 and 2.

TABLE 3

| Appearance | |
|---|---|
| ranking | Judgment standard |
| A | Sn plating not corroded |
| | Dissolution loss of aluminum wire not found |
| | Corrosion product not found (slightly) |
| B | Sn plating partially corroded (ca. 30% or less) |
| | Dissolution loss of aluminum wire not found |
| | Corrosion product attached found |
| C | Sn plating mostly corroded (ca. 30% or more) |
| | Dissolution loss of aluminum wire partially found |
| | Corrosion product found |
| D | Sn plating corroded on entire surface |
| | Dissolution loss of aluminum wire partially found |
| | Corrosion product found |
| E | Sn plating largely corroded (partially remaining) |
| | Dissolution loss of aluminum wire found (not remaining) |
| | Corrosion product found |
| F | Sn plating corroded on entire surface |
| | Dissolution loss of aluminum wire found (not remaining) |
| | Corrosion product found |

### Discussion of Results

As shown in Table 1, in Examples 1 to 4, it was confirmed that the effect of suppressing corrosion current was retained in the initial stage and after heating (at 120° C. for 168 hours). It was also confirmed that, in the evaluation of corrosion of terminal (after subjecting to salt water spraying for 168 hours), the terminal and the aluminum wire were effectively suppressed from corrosion.

On the other hand, in Comparative Example 1 using only the lubricant oil, the effect of suppressing corrosion current was not confirmed in the initial stage and after heating, and the effect of suppressing corrosion was not confirmed in the evaluation of corrosion of terminal.

Comparative Example 2 uses a surface protective agent composition that is not gelled due to the absence of the component (c) (amide). In the evaluation results thereof, both the effect of suppressing corrosion current and the effect of suppressing corrosion of terminal were confirmed in the initial stage, but it was confirmed that the effects were lost after heating. It is expected that this is because the surface protective agent composition that is not gelled flows out after leaving at a high temperature.

In Comparative Example 3, it was confirmed that the effect of suppressing corrosion and the effect of suppressing corrosion of terminal were inferior to Examples due to the absence of the component (b) (phosphorus compound). However, it was confirmed that the reduction of the effects after heating was smaller than Comparative Example 2 due to the presence of the component (c) (amide).

In Comparative Example 4, not only the component (b) (phosphorus compound) but also the component (e) (benzotriazole compound) were not contained, and it was confirmed that the effect of suppressing corrosion of terminal and the effect of suppressing corrosion of terminal were further inferior to Comparative Example 3.

As shown in Table 2, in Examples 5 to 13, it was confirmed that the effect of suppressing corrosion current was retained in the initial stage and after heating (at 120° C. for 168 hours). It was also confirmed that in the evaluation of corrosion of terminal (after subjecting to salt water spraying for 168 hours), the terminal and the aluminum wire were effectively suppressed from corrosion.

On the other hand, in Comparative Example 5 using only the lubricant oil, the effect of suppressing corrosion current was not confirmed in the initial stage and after heating, and the effect of suppressing corrosion was not confirmed in the evaluation of corrosion of terminal.

In Comparative Examples 6 to 8, it was confirmed that the effect of suppressing corrosion and the effect of suppressing corrosion of terminal were inferior to Examples due to the absence of one or both of the component (b) (phosphorus compound) and the component (d) (salicylate of an alkali metal or an alkaline earth metal, and/or a basic (or perbasic) salt thereof).

Comparative Example 9 uses a surface protective agent composition that is not gelled due to the absence of the component (c) (amide). In the evaluation results thereof, both the effect of suppressing corrosion current and the effect of suppressing corrosion of terminal were confirmed in the initial stage, but it was confirmed that the effects were lost after heating. It is expected that this is because the surface protective agent composition that is not gelled flows out after leaving at a high temperature.

### INDUSTRIAL APPLICABILITY

The surface protective agent composition of the invention can suppress corrosion of members of different kinds of metals close to each other due to corrosion current between the metals of the members, and thus is useful for suppressing corrosion of metal members of an electric connection structure containing the metal member.

Furthermore, the surface protective agent composition of the invention can enhance the corrosion resistance of a metal member even under a severe corrosive environment, and thus can be used in wiring of a transport equipment, such as a wire harness for an automobile, in which the resistance is needed.

Moreover, the electric connection structure having the surface protective agent composition of the invention coated thereon can enable the use of aluminum (or alloy thereof), which is effective for weight reduction of an vehicle, as a material of a core wire of a wire harness, and therefore can contribute to weight reduction, reduction of the fuel consumption, and reduction of the carbon dioxide emission amount of an automobile.

### REFERENCE SIGN LIST

20 electric connection structure
21 terminal
21A insulation barrel
21B wire barrel
21C body
21D depression
22 wire
22A core wire
22B insulation coating
24 surface protective layer
30 electric connection structure
31 splicing terminal
31A wire barrel
32 copper wire
32A copper core wire
32B insulation coating
33 aluminum wire
33A aluminum core wire
33B insulation coating
34 surface protective layer

1-37. (canceled)

38. A surface protective agent composition comprising:
(a) a lubricant base oil;
(b) at least one compound selected from the group consisting of a phosphorus compound represented by the following general formula (1), a phosphorus compound represented by the following general formula (2), and a metal salt or an amine salt thereof, in an amount of from 0.005 to 4% by mass in terms of phosphorus element based on the total amount of the composition: 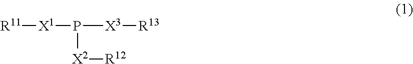
wherein in the general formula (1), X¹, X², and X³ each independently represent an oxygen atom or a sulfur atom, provided that at least one thereof represents an oxygen atom; and R¹¹, R¹², and R¹³ each independently represent a hydrogen atom or a hydrocarbon group having from 1 to 30 carbon atoms, 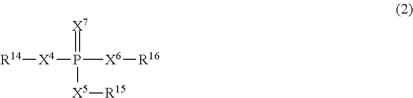
wherein in the general formula (2), X⁴, X⁵, X⁶, and X⁷ each independently represent an oxygen atom or a sulfur atom, provided that at least three thereof represent oxygen atoms; and R¹⁴, R¹⁵, and R¹⁶ each independently represent a hydrogen atom or a hydrocarbon group having from 1 to 30 carbon atoms; and
(c) an amide compound, in an amount of from 0.1 to 40% by mass based on the total amount of the composition, and
in the case where the component (b) neither contains the metal salt of the phosphorus compound represented by the general formula (1) nor the metal salt of the phosphorus compound represented by the general formula (2), the surface protective agent composition further comprising:
(d) a salicylate of an alkali metal or an alkaline earth metal having an alkyl group or an alkenyl group having from 10 to 40 carbon atoms, and/or a basic (or perbasic) salt thereof, in an amount of from 0.005 to 3.0% by mass in terms of metal element based on the total amount of the composition.

39. The surface protective agent composition according to claim 38, wherein the surface protective agent composition comprises (d) a salicylate of an alkali metal or an alkaline earth metal having an alkyl group or an alkenyl group having from 10 to 40 carbon atoms, and/or a basic (or perbasic) salt thereof, in an amount of from 0.005 to 3.0% by mass in terms of metal element based on the total amount of the composition.

40. The surface protective agent composition according to claim 38, wherein the surface protective agent composition further comprises (e) at least one metal deactivator having a nitrogen-containing heterocyclic ring in the molecule thereof, in an amount of from 0.01 to 30% by mass based on the total amount of the composition.

41. The surface protective agent composition according to claim 38, wherein the lubricant base oil (a) has a kinematic viscosity at 100° C. of from 2 to 50 mm²/s.

42. The surface protective agent composition according to claim 38, wherein the lubricant base oil (a) has % C_{P} obtained by a method determined in ASTM D3238 of less than 90%.

43. The surface protective agent composition according to claim 38, wherein the phosphorus compound represented by the general formula (1) and the phosphorus compound represented by the general formula (2) (b) each are at least one compound selected from the group consisting of metal salts thereof, and the metal is selected from the group consisting of an alkali metal, an alkaline earth metal, aluminum, titanium, and zinc.

44. The surface protective agent composition according to claim 38, wherein the phosphorus compound represented by the general formula (1) and the phosphorus compound represented by the general formula (2) (b) each are at least one compound selected from the group consisting of metal salts thereof, and the metal is any one of calcium, magnesium, and zinc.

45. The surface protective agent composition according to claim 38, wherein in the general formula (2) of at least one compound selected from the group consisting of the phosphorus compound represented by the general formula (2) and a metal salt or an amine salt thereof (b), all X⁴, X⁵, X⁶, and X⁷ are oxygen atoms, and at least one of R¹⁴, R¹⁵, and R¹⁶ is a hydrocarbon group having from 1 to 30 carbon atoms.

46. The surface protective agent composition according to claim 38, wherein in the general formula (2) of at least one compound selected from the group consisting of the phosphorus compound represented by the general formula (2) and a metal salt or an amine salt thereof (b), all X⁴, X⁵, X⁶, and X⁷ are oxygen atoms, and at least one of R¹⁴, R¹⁵, and R¹⁶ is a branched hydrocarbon group having from 8 to 30 carbon atoms.

47. The surface protective agent composition according to claim 38, wherein the amide compound (c) is at least one represented by the following general formulae (3) to (5):
R²¹—CO—NH—R²² (3)
R²³—CO—NH—Y³¹—NH—CO—R²⁴ (4)
R²⁵—NH—CO—Y³²—CO—NH—R²⁶ (5)
wherein in the general formulae (3) to (5), R²¹, R²², R²³, R²⁴, R²⁵, and R²⁶ each independently represent a saturated or unsaturated chain hydrocarbon group having from 5 to 25 carbon atoms, provided that R²² may be a hydrogen atom; and Y³¹ and Y³² each represent a divalent hydrocarbon group having from 1 to 10 carbon atoms selected from the group consisting of an alkylene group having from 1 to 10 carbon atoms, a phenylene group, and an alkylphenylene group having from 7 to 10 carbon atoms.

48. The surface protective agent composition according to claim 47, wherein the amide compound (c) is at least one represented by the general formulae (3) to (5), and is an amide compound, in which R²¹, R²², R²³, R²⁴, R²⁵, and R²⁶ each independently represent a saturated chain hydrocarbon group having from 12 to 20 carbon atoms, or R²² is a hydrogen atom, and/or an amide compound, in which at least one of R²¹ and R²², R²³ and R²⁴, and R²⁵ and R²⁶ each are an unsaturated chain hydrocarbon group having from 12 to 20 carbon atoms.

49. The surface protective agent composition according to claim 38, wherein the amide compound (c) is a fatty acid amide having a melting point of from 20 to 200° C.

50. The surface protective agent composition according to claim 38, wherein the salicylate of an alkali metal or an alkaline earth metal having an alkyl group or an alkenyl group having from 10 to 40 carbon atoms, and/or a basic (or perbasic) salt thereof (d) is calcium salicylate having an alkyl group or an alkenyl group having from 10 to 40 carbon atoms, and/or a basic (or perbasic) salt thereof.

51. The surface protective agent composition according to claim 38, wherein the salicylate of an alkali metal or an alkaline earth metal having an alkyl group or an alkenyl group having from 10 to 40 carbon atoms, and/or a basic (or perbasic) salt thereof (d) is a salicylate of an alkali metal or an alkaline earth metal having an alkyl group or an alkenyl group having from 10 to 40 carbon atoms, and/or a basic (or perbasic) salt thereof that has a metal ratio of from 1 to 7.5.

52. The surface protective agent composition according to claim 38, wherein the metal deactivator having a nitrogen-containing heterocyclic ring in the molecule thereof (e) is at least one selected from the group consisting of a benzotriazole-based compound, a tolyltriazole-based compound, a benzothiazole-based compound, a thiadiazole-based compound, and an imidazole-based compound.

53. The surface protective agent composition according to claim 40, wherein the metal deactivator having a nitrogen-containing heterocyclic ring in the molecule thereof (e) is at least one compound having a hydrocarbon group having 4 or more carbon atoms.

54. The surface protective agent composition according to claim 40, wherein the metal deactivator having a nitrogen-containing heterocyclic ring in the molecule thereof (e) is at least one compound having a linear or branched hydrocarbon group having 8 or more carbon atoms.

55. The surface protective agent composition according to claim 40, wherein the surface protective agent composition further comprises (f) an antioxidant, in an amount of from 0.01 to 5% by mass based on the total amount of the composition.

56. The surface protective agent composition according to claim 55, wherein the antioxidant (f) is at least one selected from the group consisting of a phenol-based antioxidant and an amine-based antioxidant.

57. The surface protective agent composition according to claim 55, wherein the antioxidant (f) is at least one selected from the group consisting of alkylphenol compounds and bisphenol compounds.

58. The surface protective agent composition according to claim 38, wherein the surface protective agent composition further comprises (g) a thickener, in an amount of from 0.1 to 20% by mass based on the total amount of the composition.

59. The surface protective agent composition according to claim 58, wherein the thickener (g) is at least one selected from the group consisting of a polyalkyl methacrylate, an ethylene-α-olefin copolymer and a hydrogenated product thereof, and polyisobutylene and a hydrogenated product thereof.

60. The surface protective agent composition according to claim 38, wherein the surface protective agent composition further comprises (h) grease, in an amount of from 0.1 to 10% based on the total amount of the composition.

61. The surface protective agent composition according to claim 60, wherein the grease (h) is lithium-based grease.

62. The surface protective agent composition according to claim 38, wherein the surface protective agent composition further comprises (i) a dye.

63. The surface protective agent composition according to claim 38, wherein the surface protective agent composition has a melting point of from 120 to 150° C.

64. An electric connection structure comprising a first metal member containing copper or copper alloy, and a second metal member electrically connected to the first metal member, and further comprising a surface protective layer consisting of the surface protective agent composition according to claim 38 on at least a surface of the first metal member.

65. The electric connection structure according to claim 64, wherein the first metal member containing copper or copper alloy has a tin plated layer on at least a part thereof.

66. The electric connection structure according to claim 64, wherein the second metal member is aluminum or aluminum alloy.

67. The electric connection structure according to claim 64, wherein the second metal member is an aluminum wire or an aluminum alloy wire.

68. The electric connection structure according to claim 64, wherein the second metal member is copper or copper alloy.

69. The electric connection structure according to claim 64, wherein the second metal member is a copper wire or a copper alloy wire.

70. A method for suppressing corrosion of an electric connection structure, wherein the electric connection structure containing a first metal member containing copper or copper alloy, and a second metal member electrically connected to the first metal member, and wherein the method comprising providing a surface protective layer consisting of the surface protective agent composition according to claim 38 on at least a surface of the first metal member.

71. The electric connection structure according to claim 64, wherein the surface protective layer is formed by dip-coating the surface protective agent composition heated to a melting point thereof or more.

72. A method for producing an electric connection structure according to claim 64, comprising forming the surface protective layer by dip-coating the surface protective agent composition heated to a melting point thereof or more.

73. A wire harness for an automobile, comprising the electric connection structure according to claim 64.

74. A method for reducing a weight of an automobile, using the wire harness for an automobile according to claim 73.
